(19) United States
(12) Patent Application Publication
(10) Pub. No.: US 2013/0218518 A1
(43) Pub. Date: Aug. 22, 2013

(54) AUTOMATED, THREE DIMENSIONAL MAPPABLE ENVIRONMENTAL SAMPLING SYSTEM AND METHODS OF USE

(71) Applicants: Jennifer L. DIMITRI, Fishkill, NY (US); Wilfredo FERRE, Le Mesnil le Roi (FR); William T. PETRY, Wappingers Falls, NY (US); Ernest L. TIMLIN, JR., Poughkeepsie, NY (US); Marc P. YVON, Antony (FR)

(72) Inventors: Jennifer L. DIMITRI, Fishkill, NY (US); Wilfredo FERRE, Le Mesnil le Roi (FR); William T. PETRY, Wappingers Falls, NY (US); Ernest L. TIMLIN, JR., Poughkeepsie, NY (US); Marc P. YVON, Antony (FR)

(73) Assignee: INTERNATIONAL BUSINESS MACHINES CORPORATION, Armonk, NY (US)

(21) Appl. No.: 13/419,537

(22) Filed: Mar. 14, 2012

(30) Foreign Application Priority Data
Feb. 21, 2012 (EP) 12305194.8

(51) Int. Cl. G06F 15/00

(52) U.S. Cl. 702/152; 702/189; 702/150; 702/188

(57) ABSTRACT

An automated, 3D mappable environmental sampling system and methods of use is disclosed herein. The method includes routing one or more sensors throughout a facility. The method further includes collecting environmental data on a continuous basis from the one or more sensors at various locations throughout the facility. The method further includes determining whether discrepancies exist between the collected environmental data and acceptable levels of environmental data.

### FIELD OF THE INVENTION

The invention relates to collecting environmental data in a cleanroom facility and, more particularly, to an automated, 3D mappable environmental sampling system and methods of use.

### BACKGROUND

In cleanroom facilities, environmental data collection relies on stationary sensors and/or handheld sensors. These stationary sensors are typically part of the facility structure and are not ideally positioned to detect the environment which wafers experience as they move around the facility, from process tool to process tool. To the contrary, these fixed sensors measure environmental data at one location and require interpolation or extrapolation to understand what contaminant levels might be present at locations beyond the immediate surrounding area. More specifically, fixed sensors monitor regions within their immediate vicinity, and the environmental data in unmonitored regions is estimated based on the environmental data collected by the fixed sensors.

However, interpolations and extrapolations are not an accurate assessment of the environmental data in the unmonitored regions. That is, these interpolations and extrapolations do not accurately reflect actual contaminant levels in the unmonitored regions because they are merely estimates.

Accordingly, there exists a need in the art to overcome the deficiencies and limitations described hereinabove.

### SUMMARY

In an aspect of the invention, a method comprises routing one or more sensors throughout a facility. The method further comprises collecting environmental data on a continuous basis from the one or more sensors at various locations throughout the facility. The method further comprises determining whether discrepancies exist between the collected environmental data and acceptable levels of environmental data.

In an aspect of the invention, a system implemented in hardware comprises a computer infrastructure operable to: receive environmental data from one or more sensors that are moving throughout a facility; compare the environmental data to at least one acceptable environmental data level; and determine whether the environmental data exceeds the at least one acceptable environmental data level.

In another aspect of the invention, a system comprises a computer infrastructure and one or more sensors attached to a mobile device which is structured to move in x, y, and z dimensions within a facility. The one or more sensors are configured to collect environment data at various locations in the x, y, and z dimensions within the facility. The one or more sensors provide the environmental data at the various locations to the computer infrastructure. The one or more sensors provide a time stamp with the environment data to the computer infrastructure. The computer infrastructure is structured to correlate the location and time stamp information with a location of one or more wafer lots being processed throughout the facility.

### BRIEF DESCRIPTION OF THE SEVERAL VIEWS OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a sensor mounted to a mobile device according to aspects of the present invention;

FIG. 2 shows the mobile device attached to a traveling vehicle according to aspects of the present invention;

FIG. 3 shows the collection of environmental data according to aspects of the present invention;

FIG. 4 shows additional collection of environmental data according to aspects of present invention;

FIG. 5 shows an illustrative environment for managing processes according to aspects of the present invention;

FIG. 6 is a process flow for collecting and analyzing environmental data according to aspects of the present invention; and

FIG. 7 is an alternate process flow for collecting and analyzing data according to aspects of the present invention.

### DETAILED DESCRIPTION

The invention relates to collecting environmental data in a cleanroom facility and, more particularly, to an automated, three dimensional mappable environmental sampling system and methods of use. In embodiments, the invention includes a sensor mounted to a traveling vehicle. In embodiments, the sensor is deployed to either move randomly or along a predetermined path to collect environmental data, such as safety data, processing data, production data and/or environmental suitability data, etc.

Advantageously, the present invention includes a system which provides for dynamic, programmable, and mappable, three dimensional (3D) environmental data collection in a semiconductor cleanroom, or any other type of facility. More specifically, the present invention provides a system that can either randomly, or in a predetermined route, move about a cleanroom facility to collect environmental and other data rather than relying on interpolations and extrapolations of environmental data from stationary sensors and/or handheld sensors. Accordingly, the present invention provides a system that can collect information in specific areas and/or locations for systematic monitoring, collection of data, and mapping of environmental conditions. As such, the present invention provides for a detailed mapping of a cleanroom that was not otherwise achievable with the use of stationary sensors and/or handheld sensors. The data collection can be used to proactively obtain data in order to ensure certain conditions are met, or that certain conditions exist (or do not exist) in order to ensure the production of quality products.

The present invention also provides for continuous environmental data collection and mapping. The continuous data collection can be programmed for 24 hours a day, 365 days a year, in order to obtain and map environmental conditions in real-time. The environmental data collected can be of any type of data, for example, safety data, processing data, production data and/or environmental suitability data, amongst other information. Also, advantageously, the present invention reduces the number of sensors necessary to collect environmental data, thereby increasing efficiency, decreasing inter-sensor variability, and reducing costs.

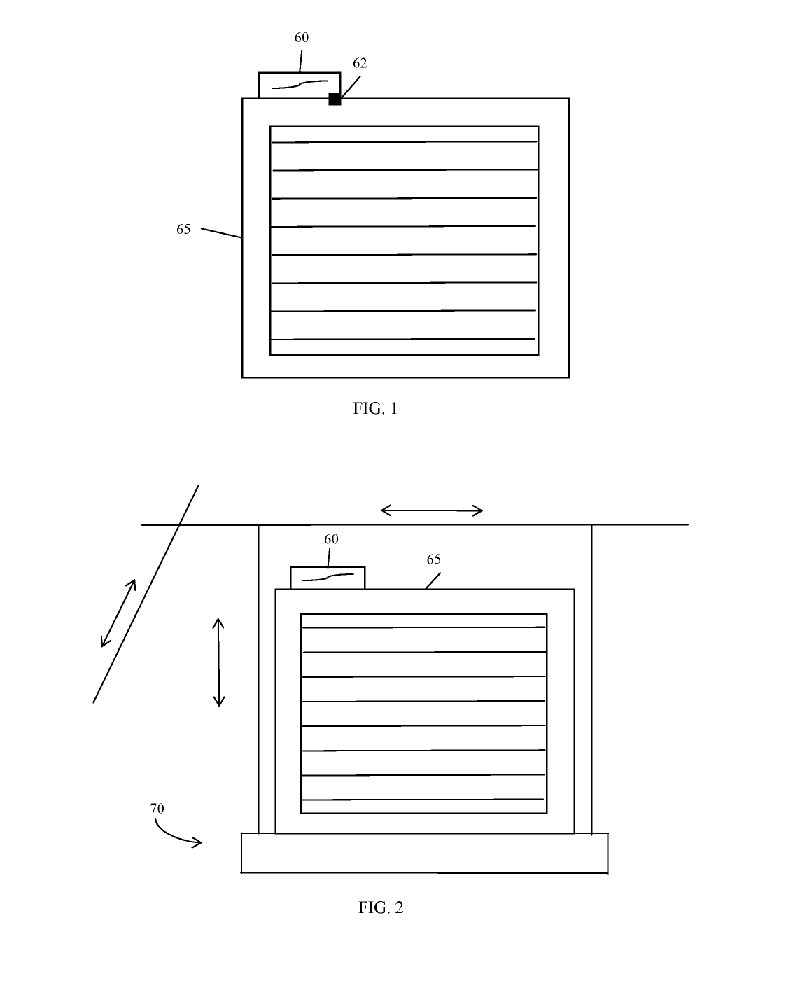

FIG. 1 shows one or more sensors attached to a mobile device according to aspects of the present invention. More specifically, FIG. 1 shows a sensor 60 mounted to a mobile device 65. It should be understood by those of skill in the art that the sensor 60 can be two or more sensors. In embodiments, the sensor 60 may be a sensor that has its own dedicated source of power or is battery-operated. In embodiments, the mobile device 65 includes a mount 62 which is provided to mount the sensor 60 to the mobile device 65.

In embodiments, the mobile device 65 is a wafer carrier, such as a Front Opening Unified Pod (FOUP). A FOUP has various coupling plates, pins and holes to allow the FOUP to be located on a load port, and to be manipulated by an Automated Material Handling System (AMHS). In embodiments, these features may be used to modify the FOUP to mount the sensor 60 thereon. Additionally, the FOUP may contain radio frequency (RF) tags that allows it to be identified by readers on processing tools or at other locations in the facility, in order to maintain constant tracking of the location of the FOUP and/or sensor 60 throughout a facility.

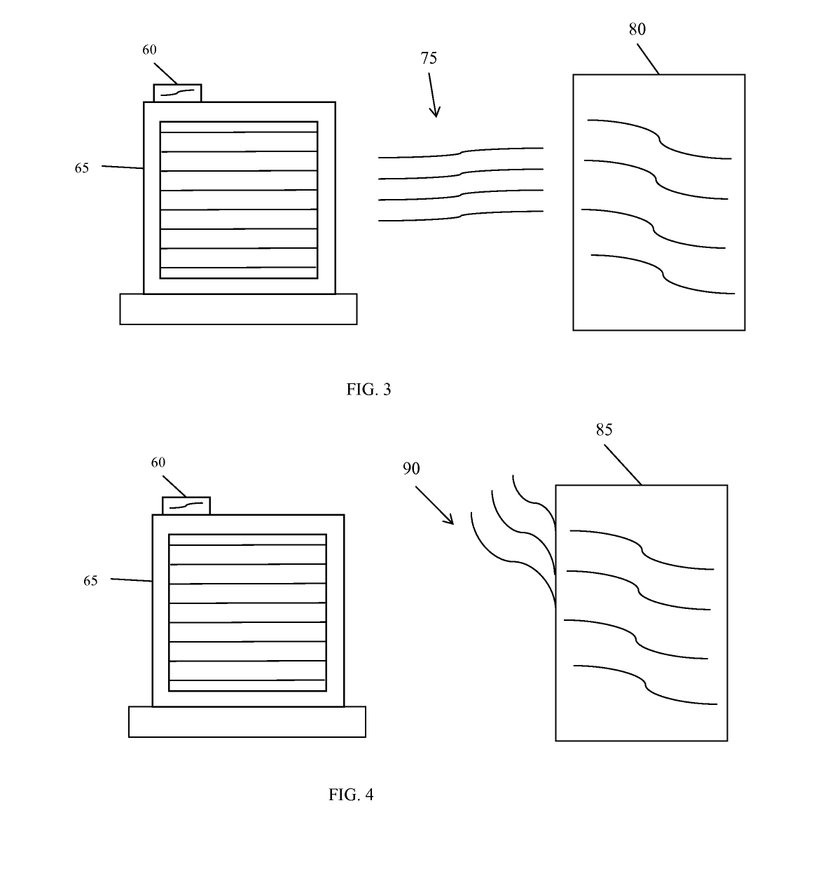

FIG. 2 shows a highly schematic view of the mobile device 65 placed on a traveling vehicle 70. In embodiments, the traveling vehicle 70 is an inter-bay or intra-bay automated overhead traveling vehicle. The inter-bay traveling vehicle 70 provides for the transportation of quantities of in-process items between processing tools in a cleanroom of a semiconductor fabrication facility. In embodiments, the inter-bay vehicle 70 can transport the FOUP both horizontally and vertically, and thus can lower and raise the sensor 60 between a ceiling level and a “floor level,” e.g., to a loading station, in order to obtain sensor readings at several different heights in the cleanroom. This is advantageous because certain contaminants can settle at certain heights within the cleanroom.

In alternate embodiments, the traveling vehicle 70 is an intra-bay automated overhead traveling vehicle. The intra-bay traveling vehicle 70 provides transportation between one bay area to another bay area across the cleanroom facility. Advantageously, an intra-bay traveling vehicle 70 effectively utilizes ceiling space and provides a unified track delivery system capable of transporting the sensor 60 anywhere in the cleanroom. This, advantageously, allows the sensor 60 to obtain sensor readings at different locations throughout the cleanroom.

Accordingly, the sensor 60 shown in FIG. 2 is capable of traveling through the entire cleanroom in three dimensions, i.e., the x, y, and z coordinates. As a result, the sensor 60 is capable of collecting environmental data from regions of the cleanroom that were previously inaccessible with the use of stationary and/or handheld sensors. Also, in embodiments, the sensor 60 can be sent to specific areas and/or locations of focus, which can be analyzed strategically by re-routing map data and increasing sample rates. Also, in embodiments, through mappings, e.g., preselected rates of travel, the sensor 60 can be repetitively sent to a same or different locations in the cleanroom facility at preselected times. This ensures that certain tools, for example, that use volatile chemicals can be monitored on a constant and consistent monitoring schedule. This also allows for more data sampling thereby resulting in more accurate monitoring.

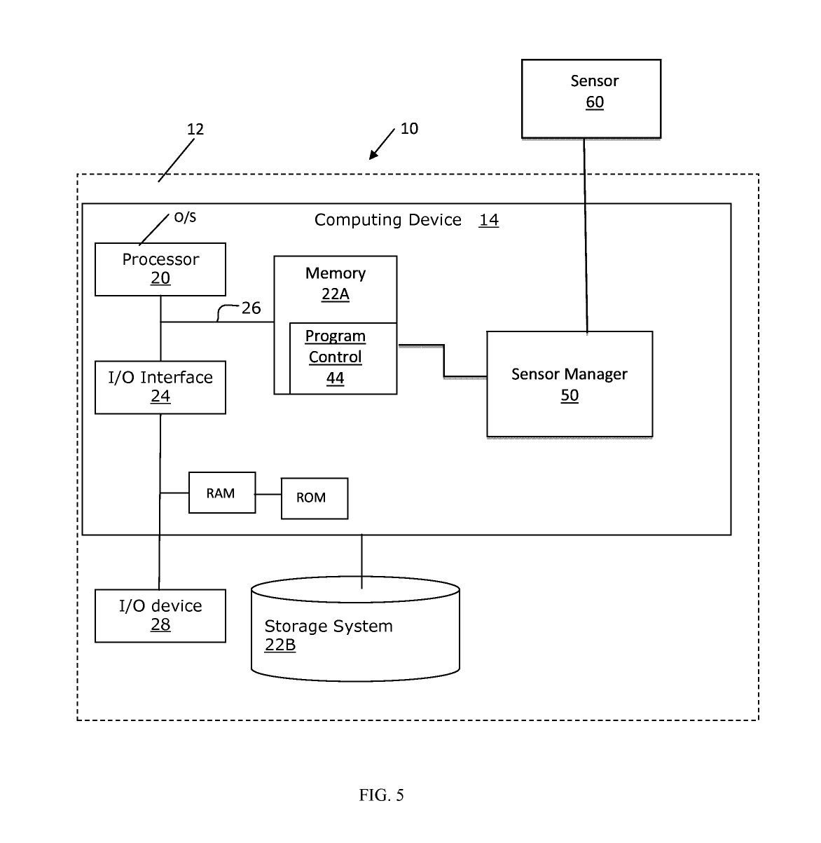

In embodiments, the mobile device 65 may be programmed to travel in a cleanroom. When the mobile device 65 is deployed, the location of the sensor 60 can be determined in a variety of fashions. In embodiments, for example, the location of the sensor 60 can be determined using landmarks, such as by recognizing the tool being monitored and knowing the location of such tool. Alternatively, or in addition, the location of the sensor 60 can be determined using known spatial coordinates of the room being monitored. Alternatively, or in addition, the location of the sensor 60 can be determined by an encoder mounted to the traveling vehicle 70, which can determine the location of the sensor by, e.g., revolutions of an electric motor. In further embodiments, a sensor or monitoring system can be placed along a track of the traveling vehicle 70 to determine the exact location of the sensor 60. Moreover, in embodiments, the location of the sensor 60 can be determined with a global positioning system (GPS). In still further embodiments, the location of the sensor 60 can be determined using RF signals emitted from RF tags, such as those provided on the FOUP. In embodiments, the height of the sensor 60 can be determined using an accelerometer. In addition, a time stamp can be transmitted with the location information to a computing system 12 (see, FIG. 5) to store the exact time and location information of the sensor 60.

As should be understood and as shown in FIG. 3, the sensor 60 is capable of collecting a host of different environmental data related to the production of semiconductor chips, safety information, and maintenance information of processing tools, as several non-limiting examples. For example, the sensor 60 can collect information in an intervening, filtered airspace 75 between the mobile device 65 and a load lock 80. In embodiments, for example, the intervening airspace 75 can contain contaminants such as ammonia, carbon dioxide, or other gaseous air contaminants emitted from the processing tool, which can damage or lower the yield of the wafers being processed. The sensor 60 can thus detect such contaminants, in addition to, e.g., volatile organic compounds (VOC), total organic compounds, and isopropyl alcohol (IPA).

In this way, the sensor 60 can collect environmental data to determine whether the wafer(s) was exposed to particulates before any further processes are performed on the wafer. More specifically, when contaminants are detected in the intervening airspace 75, the sensor 60 can provide such information to the computing system 12 (see, FIG. 5), which is monitored by a technician. The technician would thus be notified of a potential issue in real-time, which can then be resolved prior to further processing. Accordingly, the sensor 60 can collect environmental data and use such information to improve manufacturing yields. In further embodiments, the collected information can be saved in the computing system 12, and further tabulated to provide a 3D mapping of environmental conditions in the facility.

In FIG. 4, the sensor 60 is shown collecting data related to maintenance issues of the processing tool. For example, as shown in FIG. 4, a processing tool 85 can emit electromagnetic (EM) fields 90 or other forms of noise or pollution. The sensor 60 can be used to determine when these EM fields 90 exceed certain levels, which may adversely affect neighboring tools. More specifically, the sensor 60 can proactively detect, e.g., early detection, cross-talk, i.e., EM fields 90, between processing tools 85 in order to monitor the EM fields 90, and provide such information to a technician in real-time. In this way, the technician can be alerted of such cross-talk and take proactive steps to alleviate any related issues, thus minimizing any yield issues.

It should be understood by those of ordinary skill in the art that the present invention is capable of collecting other information, such as tool noise in the cleanroom. For example, the sensor 60 can be configured to monitor any contaminants that may affect the processing tool 85. For example, the collected data can be used to determine whether the processing tool 85 has been exposed to harmful particulates, and may even use such information to map such contaminants, determine its source, and allow a technician to attend to any perceived issues.

In still further embodiments, the environmental data collected can be related to safety issues. For example, the sensor 60 can be deployed to a specific work area to determine if contaminants are present near a technician's station, etc. Thus, in embodiments, specific work areas may be proactively monitored by the sensor 60 by programming it to travel certain routes during the manufacturing process to monitor environmental data, such as EM fields 90 and contaminant levels. Moreover, during the maintenance of predetermined tools, the sensor 60 can be sent to specific locations to ensure that the technicians are not exposed to unacceptable amounts of EM fields 90 of the neighboring tools and/or other contaminants. As such, the sensor 60 can be programmed to travel to areas where maintenance is being performed.

Referring to FIG. 5, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

More specifically, FIG. 5 shows an illustrative environment 10 for managing the processes in accordance with the invention. To this extent, the environment 10 includes a server or other computing system 12 that can perform the processes described herein. In particular, the server 12 includes a computing device 14. The computing device 14 can be resident on a network infrastructure or computing device of a third party service provider (any of which is generally represented in FIG. 5).

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with the external I/O device/resource 28 and the storage system 22B. For example, the I/O device 28 can comprise any device that enables an individual to interact with the computing device 14 (e.g., user interface) or any device that enables the computing device 14 to communicate with one or more other computing devices using any type of communications link. The external I/O device/resource 28 may be for example, a handheld device, PDA, handset, keyboard etc.

The processor 20 executes computer program code (e.g., program control 44), which can be stored in the memory 22A and/or storage system 22B. While executing the computer program code, the processor 20 can read and/or write data to/from memory 22A, storage system 22B, and/or I/O interface 24. Moreover, in accordance with aspects of the invention, the program control 44 controls a sensor manager 50, e.g., the processes described herein.

The sensor manager 50 communicates with one or more sensors 60 traveling throughout a facility in order to carry out processes of the invention. For example, the sensor manager 50 can receive environmental data from the sensor 60, throughout the facility, and compare the measurements to known and/or acceptable contaminant levels. In this way, the sensor manager 50 can use the environmental data to determine whether contaminant levels exceed acceptable levels. The sensor manager 50 can also notify users of any anomalies between known and/or acceptable environmental data and the collected environmental data.

The sensor manager 50 is further configured to identify patterns, e.g., abnormal activities, and provide predictive analysis. More specifically, the sensor manager 50 can use the data collected from the one or more sensors 60 and map this information into a 3D map. The 3D map may be used to determine patterns, e.g., contaminant levels and low yields, in order to make recommendations to a technician. In embodiments, for example, the sensor manager 50 can obtain the collected information, correlate the collected information, and determine patterns between wafer yields and environmental conditions. If an environmental issue is found to be correlated to the lower yield, the computing system 12 can then provide such information to the technician. This information may include, for example, the environmental contaminants, the location of the environmental contaminants, the time the contaminants were detected, and any wafer lots that passed through the location of the environmental conditions at a certain time. Taking this information, the sensor manager 50 can determine whether the yield of a certain lot passing through a certain location at a certain time, has a lower yield than other wafer lots. By making this correlation, it is possible to determine, with some certainty, the cause of the lower yield, and attend to correcting such issue.

The sensor manager 50 is also configured to provide the travel route of the sensor 60 throughout the facility in x, y, and z directions. For example, the sensor manager 50 can provide instructions to the traveling vehicle 70 to travel certain, predefined routes, at certain times. In one illustrative example, the sensor manager 50 can provide instructions to the traveling vehicle 70 to monitor processing tools that are currently or soon to be processed wafers. Alternatively, the sensor manager 50 can request the sensor 60 to travel in a random route depending on the desires of the technician.

While executing the computer program code, the processor 20 can read and/or write data to/from memory 22A, storage system 22B, and/or I/O interface 24. The program code executes the processes of the invention such as, for example, pairing the time and location to the environmental data collected by the sensor 60, programming specific routes for 3D mapping and environmental data collection, transferring environmental data at programmed time intervals and/or in real-time to aggregate and analyze the environmental data, forming predictive data for both real-time and logging results, and aggregating data over time to predict trends. In embodiments, the computing system 12 issues commands to the sensor 60, and further controls and monitors the status of the sensor 60. It should be understood by those of ordinary skill in the art that multiple functions can be performed in the same unit.

Thus, the present invention is configured and structured to:

(i) provide the collected environmental data to a computing system;

(ii) map the collected environmental data into a 3D map;

(iii) determine patterns based on the 3D map;

(iv) provide recommendations to the user based on the patterns; and

(v) predict wafer semiconductor yield based on the mapping and the determination of patterns.

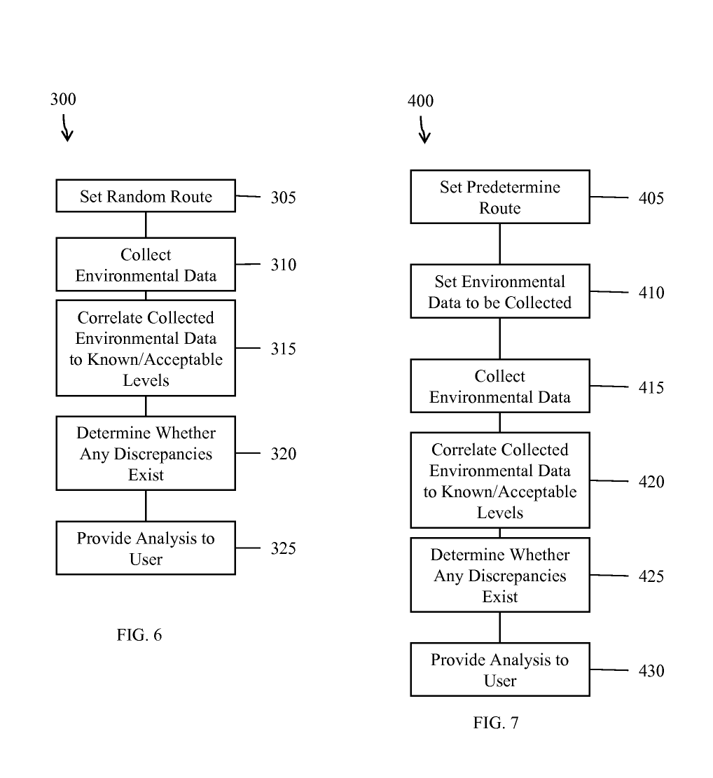

FIG. 6 shows a process flow for collecting and analyzing environmental data according to aspects of the present invention. More specifically, the process flow 300 includes setting the sensor to randomly travel within the cleanroom facility, at step 305. In this way, the sensor is capable of proactively measuring environmental data throughout different areas of the cleanroom facility. At step 310, the sensor collects environmental data. After the environmental data has been collected, the process further includes providing this information to a computer system (e.g., computing system 12 of FIG. 5) so that such information may be correlated to known and/or acceptable environmental data, at step 315. At step 320, the sensor manager determines whether any discrepancies exist between the collected environmental data and the known and/or acceptable environmental data. For example, the sensor manager may determine if EM fields emitted by a processing tool or certain contaminants at certain locations exceed acceptable levels, thereby indicating that the processing tool may be in need of repair or the processing tool may require adjustment. Subsequently, at step 325, the sensor manager provides analysis of the environmental data to the user.

FIG. 7 shows an alternate process flow for collecting and analyzing environmental data according to aspects of the present invention. More specifically, the process 400 includes setting the sensor to travel a predetermined route, at step 405. In this way, the sensor may be deployed to monitor a specific processing tool or a particular region of the cleanroom. For example, the sensor can be deployed to certain locations at certain times to ensure that processing conditions are satisfactory during wafer production of certain lots. Thus, the sensor can be deployed to collect contaminant levels of a processing tool or to monitor EM fields during wafer processing or maintenance.

The process further includes programming the sensor to collect environmental data, at step 410. In embodiments, the sensor may be programmed to collect a specified or targeted type of environmental data. In this way, areas of focus can be analyzed strategically by re-routing the map data and increasing sampling rates. In alternate embodiments, the sensor can be programmed to collect all of the environmental data along the predetermined route. At step 415, the sensor collects the environmental data. At step 420, the environmental data is correlated to known and/or acceptable environmental data by the sensor manager. At step 425, the sensor manager determines whether any discrepancies exist between the collected environmental data and the known and/or acceptable environmental data. For example, the sensor manager may determine if the EM fields being emitted by a processing tool exceed acceptable levels, thereby indicating that the processing tool may be in need of repair. Of course, the present invention also contemplates other data correlations. Subsequently, at step 430, the sensor manager provides analysis of the environmental data to the user.

The method as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method comprising:
routing one or more sensors throughout a facility;
collecting environmental data on a continuous basis from the one or more sensors at various locations throughout the facility; and
determining whether discrepancies exist between the collected environmental data and acceptable levels of environmental data.

2. The method of claim 1, wherein the routing comprises providing instructions for the one or more sensors to travel a random route within the facility.

3. The method of claim 1, wherein the routing comprises providing instructions for the one or more sensors to travel in a predetermined route within the facility.

4. The method of claim 1, further comprising:
determining a location of the one or more sensors being routed throughout the facility;
transmitting the location of the one or more sensors to a computing system for storage; and
correlating the collected environmental data with the location of the one or more sensors to determine whether the discrepancies exist at the location.

5. The method of claim 4, wherein the location of the one or more sensors is determined using at least one of:
landmarks within the facility;
known spatial coordinates of the facility;
an encoder mounted to a traveling vehicle; and
a monitoring system placed along a track of a traveling vehicle which houses the one or more sensors.

6. The method of claim 4, wherein the location of the one or more sensors is time stamped, which is provided and stored in the computing system.

7. The method of claim 6, further comprising determining wafer yield by correlating the location, time stamp information and the collected environmental data obtained from the one or more sensors with a known location or locations of one or more wafers within the facility during processing at a known time.

8. The method of claim 1, wherein the determining is provided to a user in real-time.

9. The method of claim 1, further comprising repetitively sending the one or more sensors to a same location at preselected times.

10. The method of claim 1, wherein the one or more sensors is configured to collect at least one specific type of environmental data.

11. The method of claim 1, further comprising:
providing the collected environmental data to a computing system;
mapping the collected environmental data into a 3D map;
determining patterns based on the 3D map; and
providing recommendations to a user based on the patterns.

12. The method of claim 11, further comprising predicting wafer yield based on the mapping and the determination of patterns.

13. A system implemented in hardware, comprising:
a computer infrastructure operable to:
receive environmental data from one or more sensors that are moving throughout a facility;
compare the environmental data to at least one acceptable environmental data level; and
determine whether the environmental data exceeds the at least one acceptable environmental data level.

14. The system of claim 13, wherein the computer infrastructure is further operable to map the collected environmental data into a 3D map.

15. The system of claim 14, wherein the computer infrastructure is further operable determine patterns based on the 3D map.

16. The system of claim 13, wherein the computer infrastructure is further operable to:
provide routes for 3D mapping and environmental data collection of the one or more sensors;
correlate a time and a location to the environmental data collected by the one or more sensors;
transfer environmental data in real-time to aggregate and analyze the environmental data; and
provide predictive data at least one of real-time and logging results based on the collected environmental data and correlated time and location.

17. The system of claim 13, wherein the computer infrastructure is further operable to provide a route of the one or more sensors throughout the facility.

18. A system comprising:
a computer infrastructure; and
one or more sensors attached to a mobile device which is structured to move in x, y, and z dimensions within a facility, wherein
the one or more sensors are configured to collect environmental data at various locations in the x, y, and z dimensions within the facility;
the one or more sensors provide the environmental data at the various locations to the computer infrastructure;
the one or more sensors provide a time stamp with the environmental data to the computer infrastructure; and
the computer infrastructure is structured to correlate the location and time stamp information with a location of one or more wafer lots being processed throughout the facility.

19. The system of claim 18, wherein the one or more sensors are mounted to a wafer carrier mounted on a traveling vehicle.

20. The system of claim 19, wherein the computer infrastructure is structured to provide a 3D mapping of the environmental data collected by the one or more sensors, and use this 3D mapping to provide predictive analysis.
